(19) United States
(12) Patent Application Publication
(10) Pub. No.: US 2017/0009801 A1
(43) Pub. Date: Jan. 12, 2017

(54) OPTIMIZED HOLLOW CAST IRON CRANKSHAFT

(71) Applicant: GM GLOBAL TECHNOLOGY OPERATIONS LLC, Detroit, MI (US)

(72) Inventors: Sebastian FUNK, Ruesselsheim (DE); Frank HILGER, Ruesselsheim (DE)

(73) Assignee: GM GLOBAL TECHNOLOGY OPERATIONS LLC, Detroit, MI (US)

(21) Appl. No.: 15/206,875

(22) Filed: Jul. 11, 2016

(30) Foreign Application Priority Data
Jul. 11, 2015 (DE) 102015009023.2

(51) Int. Cl. F16C 3/14; F02F 7/00; F02F 3/00; F01M 1/06; F02F 1/00

(52) U.S. Cl. CPC F16C 3/14; F01M 1/06; F02F 1/00; F02F 3/00; F02F 7/0002; F01M 2001/062

(57) ABSTRACT

A hollow cast iron crankshaft of an internal combustion engine includes at least one main bearing journal and at least two connecting rod bearing journals. The crankshaft is provided with a plurality of internal oil supply bores to lubricate the connecting rod bearing journals. An outer circumference of the main bearing journal is in fluid communication with an outer circumference of two connecting rod bearing journals by the supply bores.

### CROSS-REFERENCE TO RELATED APPLICATION

This application claims priority to German Patent Application No. 102015009023.2, filed Jul. 11, 2015, which is incorporated herein by reference in its entirety.

### TECHNICAL FIELD

The present disclosure pertains to a hollow cast iron crankshaft for an internal combustion engine, particularly suitable for spark-ignition engines or gasoline engines. The hollow casted crankshaft is optimized for oil supply.

### BACKGROUND

As known, the crankshaft, sometimes abbreviated to “crank,” is the part of an internal combustion engine that translates reciprocating linear piston motion into rotation. To convert the reciprocating motion into rotation, the crankshaft has additional bearing surfaces whose axis is offset from a central longitudinal axis of the crank, to which one end of the connecting rods from each cylinder attach. Large engines are usually multi-cylinder to reduce pulsations from individual firing strokes, with more than one piston attached to a complex crankshaft.

The crankshaft rotates about its central longitudinal axis, typically with several bearing journals riding on replaceable bearings (the main bearings) held in the engine block. As the crankshaft undergoes a great deal of sideways load from each cylinder in a multi-cylinder engine, it must be supported by several such hearings, not just one at each end. The crankshaft also includes connecting rod bearing journals for supporting storage of connecting rods.

Crankshafts can be forged from a steel bar usually through roll forging or cast in ductile steel. Today some engines use cast iron crankshafts for low output versions (which are mostly cost driven) while the more expensive high output version use forged steel.

An also known aim of the engine manufacturers is to decrease more and more the global weight of the engine in general and of components in particular, thus getting a reduction of CO2 emissions. In general, ductile cast iron is used for a cast crankshaft. In this case, however, the entire weight of the crankshaft increases because the shaft diameter has to be made larger in order to ensure the mechanical properties. A hollow crankshaft that is formed by enveloped-casting a thin-walled metal pipe to be bonded to the inside of the crankshaft is known as a solution of the above problem. In this crankshaft, reduction in weight is achieved.

Other improvements can be reached working on the oil supply circuit, in order to reduce the oil flow and consequently the oil pump power. Therefore a need exists for a crankshaft, whose design contributes to the above target.

### SUMMARY

The present disclosure provides a crankshaft for an internal combustion engine, whose design is able to positively impact on engine weight and oil flow amount, obtaining a remarkable reduction of both. In particular, a hollow cast iron crankshaft is provided for an internal combustion engine. An embodiment of the disclosure provides a hollow cast iron crankshaft of an internal combustion engine having at least one main bearing journal, at least two connecting rod bearing journals. The crankshaft has a plurality of internal oil supply bores to lubricate the connecting rod bearing journals. An outer circumference of the main bearing journal is fluid connected with an outer circumference of two connecting rod bearing journals by the supply bores. An advantage of this combination of a hollow cast iron crankshaft with the present oil supply, it is possible to have a weight optimized crankshaft in combination with a reduced oil flow amount. Consequently, these features imply a reduced oil pump power and CO2 reduction.

According to another embodiment, a first oil supply bore is provided to fluid connect the main bearing journal with a first connecting rod bearing journal and a second oil supply bore is provided to fluid connect the same main bearing journal with a second connecting rod bearing journal. As an advantage, it is possible to reduce the oil flow amount, which is needed by the crankshaft bearings.

According to a still further embodiment, each oil supply bore bridges a hollow space of the crankshaft. An advantage of this embodiment is that it combines the hollow crankshaft with an optimized oil circuit, thus keeping both advantages of the two features.

According to another embodiment the oil supply bores are casted. An advantage of this embodiment is that casting would be cheaper and can reduce tool investment.

According to still another embodiment, the oil supply bores are drilled. An advantage of this embodiment is that it simplifies the manufacturing operations.

Another embodiment of the disclosure provides an internal combustion engine provided with a hollow cast iron crankshaft according to any of the previous embodiments.

### BRIEF DESCRIPTION OF THE DRAWINGS

The present invention will hereinafter be described in conjunction with the following drawing figures, wherein like numerals denote like elements.

FIG. 1 is a section of an internal combustion engine;

FIG. 2 is a front view of the hollow cast iron crankshaft according to an embodiment of the present invention;

FIG. 3 is a front view of a detail of the crankshaft of FIG. 2; and

FIG. 4 is a side view of a detail of the crankshaft of FIG. 2;

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

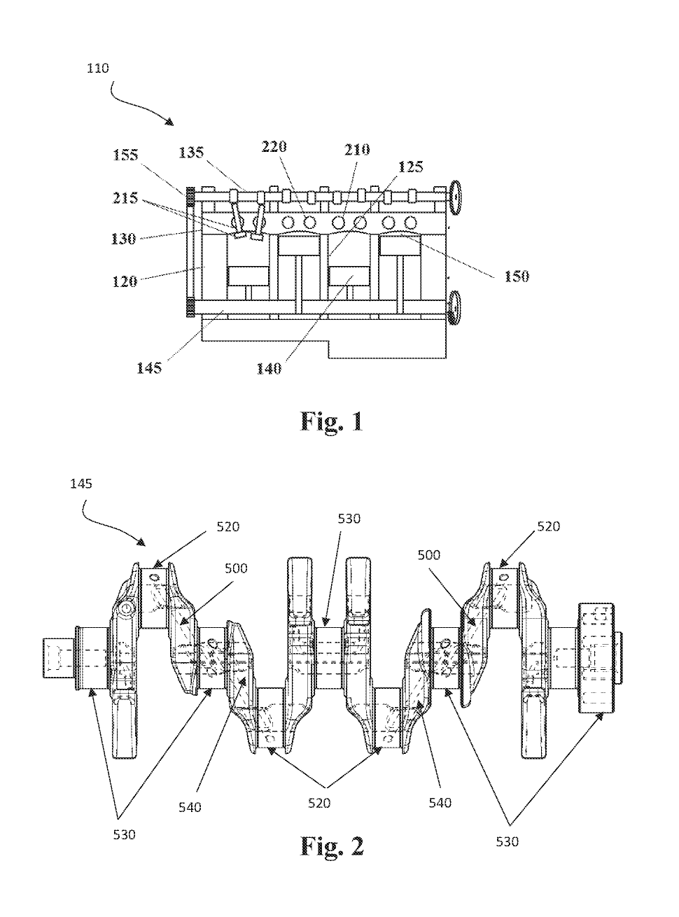

Some embodiments may include an internal combustion engine (ICE) 110, as shown in FIG. 1, having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

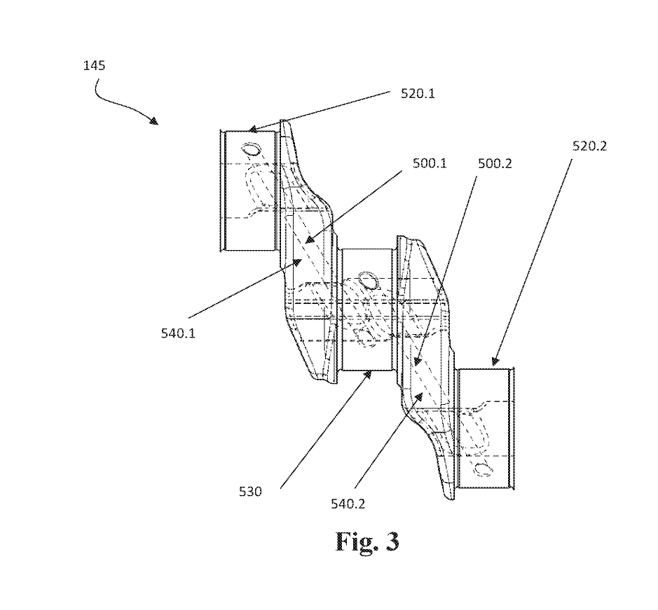

According to an embodiment of the present invention, a combination of a hollow cast iron crankshaft 145 with an oil supply layout in which one main bearing feeds two rod bearings as hereafter described. FIG. 2 is a front view of the hollow cast iron crankshaft 145 according to an embodiment of the present invention. In this example the crankshaft is suitable for a four cylinder engine having the seat for four connecting rod. The hollow cast iron crankshaft 145 is provided with a plurality of oil supply bores 500 for lubricating the main and connecting rod bearings, such bores bridging the hollow spaces 540 in the crankshaft and delivering the lubricating oil from the main bearings to the connecting rod bearings.

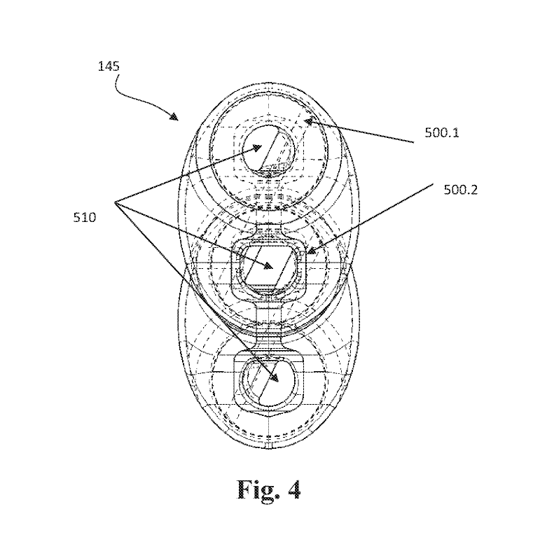

FIGS. 3-4 respectively represent a front and a side view of a detail of the crankshaft of FIG. 2. From these figures, the main characteristic of the oil supply layout is highlighted. In fact, in the hollow cast crankshaft 145 one main bearing journal 530 is connected with two connecting rod bearing journal 520, in other words, an outer circumference of the main bearing journal 530 is connected with an outer circumference of two connecting rod bearing journals 520, by the supply bores 500.

More in detail, among the plurality of oil supply bores, a first oil supply bore 500.1 is provided to connect the main bearing journal 530 with a first connecting rod bearing journal 520.1 bridging a first hollow space 540.1. A second oil supply bore 500.2 is provided to connect the same main bearing journal 530 with a second connecting rod bearing journal 520.2 bridging the second hollow space 540.2. The oil supply bores 500 are preferably casted. As an alternative, the oil supply bores 500 can also be realized by drilling.

As a result of this oil supply layout and the combination of a hollow cast iron crankshaft with the disclosed oil supply, it is possible to have a weight optimized crankshaft in combination with a reduced oil flow. Consequently, these features imply a reduced oil pump power and CO2 reduction.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-6. (canceled)

7. A crankshaft for an internal combustion engine comprising a hollow cast iron crank having a main bearing journal and first and second connecting rod bearing journals formed thereon, the crank having a plurality of internal oil supply bores configured to lubricate the connecting rod bearing journals including a first oil supply bore providing fluid communication the main bearing journal to outer circumference of the first connecting rod bearing journal and a second oil supply bore providing fluid communication from the main bearing journal to outer circumference of the second connecting rod bearing journal.

8. The crankshaft according to claim 1, wherein the first oil supply bore is provided to fluidly connect an outer circumference of the main bearing journal with an outer circumference of the first connecting rod bearing journal and a second oil supply bore is provided to fluidly connect the outer circumference of the main bearing journal with an out circumference of the second connecting rod bearing journal.

9. The crankshaft according to claim 7, wherein the crank has a first hollow space formed therein between the main bearing journal and the first connecting rod bearing journal and a second hollow space formed therein between the main bearing journal and the second connecting rod bearing journal, wherein the first and second oil supply bores bridge the first and second hollow spaces, respectively.

10. The crankshaft according to claim 7, wherein the first and second oil supply bores are casted into the crank.

11. The crankshaft according to claim 7, wherein the first and second oil supply bores are drilled into the crank.

12. The crankshaft according to claim 7, wherein the first oil supply bore terminates at a first location on the outer circumference of the main bearing journal and the second oil supply bore terminates at a second location on the outer circumference of the main bearing which is diametrically opposed to the first location.

13. An internal combustion engine comprising having an engine block having at least two cylinder, each cylinder supporting a piston coupled by a connecting rod to rotate the crankshaft according to claim 7.
